(19) United States
(12) Patent Application Publication
(10) Pub. No.: US 2009/0103827 A1
(43) Pub. Date: Apr. 23, 2009

(54) METHODS, SYSTEMS, AND APPARATUSES THAT COMPENSATE FOR NOISE GENERATED IN AN IMAGER DEVICE

(76) Inventors: John Ladd, Boise, ID (US); Gennadiy Agranov, Boise, ID (US); Johannes Solhusvik, Haslum (NO); Trygve Willassen, Oppegard (NO)

Correspondence Address: Richard A. Henkler;Micron Technology, Inc., 8000 S. Federal Way, Mail Stop 1-525, Boise, ID, 83716, US

(21) Appl. No.: 11/875,101

(22) Filed: Oct. 19, 2007

(51) Int. Cl. G06K 9/40; H04N 5/217

(52) U.S. Cl. 382/260; 348/241; 348/E05.078

(57) ABSTRACT

Methods, systems and apparatuses for using regular and/or dark pixels of a pixel array in either a fixed or dynamic fashion to compensate for fixed pattern noise.

### FIELD OF THE INVENTION

Embodiments of the present invention generally relate to electronic image capture systems using an imager device and, more specifically, to compensating for noise generated by components of the imager device.

### BRIEF DESCRIPTION OF RELATED ART

The use of electronic image capture systems has rapidly expanded from basic capture applications such as picture and video to intelligent decision type applications such as collision avoidance and object recognition. As a result, the ability to accurately and quickly capture an image has become paramount to current and future applications of these systems.

In general, an electronic image capture system uses an imager device having a two dimensional array of sensors with each sensor (pixel) having a photosensitive device, that generates an electrical signal in response to being struck by electromagnetic radiation such as photons, and circuitry for storing and amplifying the generated signal.

During the retrieval of these stored signals, noise can be introduced as a result of various factors such as process and device variations. Noise that can be reproduced in a repeatable pattern is often referred to as Fixed Pattern Noise (FPN). Various techniques such as the use of dark pixels and algorithms have evolved for compensating for FPN but, unfortunately, they are often complex and/or consume valuable image processing time.

### BRIEF DESCRIPTION OF TIE DRAWINGS

FIG. 1 is a block diagram illustrating an embodiment of the present invention as an electronic imager capture system having an imager device.

FIG. 2 is a diagram illustrating the pixel array of FIG. 1 having both dark and non-dark pixels.

FIG. 3 is a diagram illustrating in greater detail an embodiment of the column driver and pixel array of FIG. 1.

FIG. 4 is a schematic diagram illustrating in greater detail an embodiment of a pixel and the corresponding sample and hold circuit of FIG. 3.

FIG. 5 is an embodiment of a timing diagram illustrating the timing of the signals for the implementation of a Correlated Double Sampling (CDS) method using pixel and sample hold circuit of FIG. 4 as an example

FIG. 6 is an embodiment of a timing diagram illustrating the timing of the signals for the implementation of a modified CDS scheme using the pixel and sample hold circuit of FIG. 4 as an example.

FIG. 7 is a flow chart illustrating an example of an embodiment of a method for selecting and dynamically changing the number and location of Fixed Pattern Noise (FPN) pixels.

FIGS. 8A-G illustrate various dynamic selections of FPN pixels according to a desired compensation scheme for Fixed Pattern Noise.

### DETAILED DESCRIPTION

The present invention is explained below in connection with various embodiments such as an electronic image capture system. These embodiments are solely for the purpose of providing a convenient and enabling discussion of the general applicability of the present invention, and therefore, not intended to limit the various additional embodiments or applications to which the present invention can be applied as defined in the claims and their equivalents. In some instances, steps which follow other steps may be reversed, be in a different sequence or be in parallel, except where a following procedural step requires die presence of a prior procedural step.

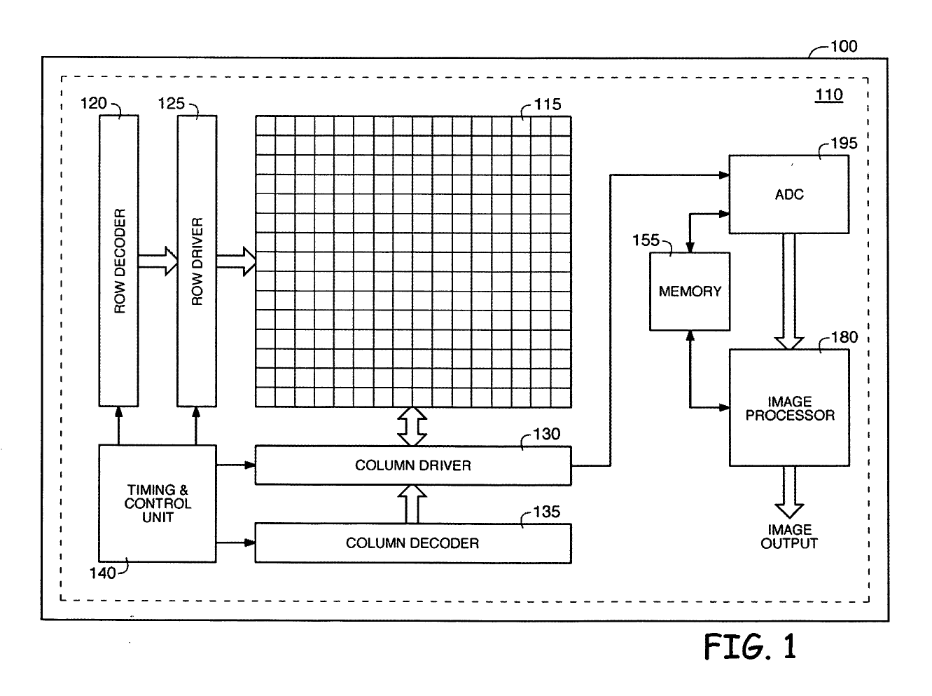

Reference now being made to FIG. 1, a block diagram is shown illustrating an embodiment of the present invention as an electronic imager capture system 100 having an imager device 110. Electronic imager capture system 100 can be any image capture device such as, for example, a camera, video recorder, security camera, object recognition, or cell phone. The use, implementation, and interaction of such systems 1100 with an imager device, such as imager device 110, are well known and understood in the relevant art. Consequently, these types of details are limited in their discussion below in order to not obscure the embodiment.

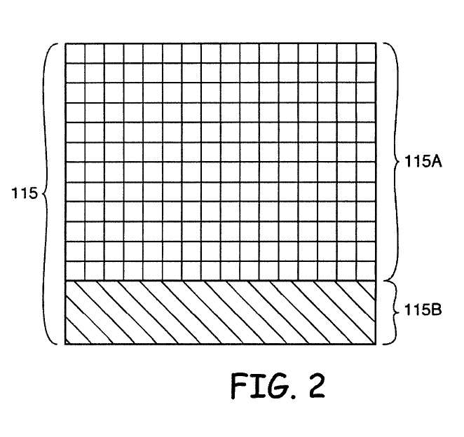

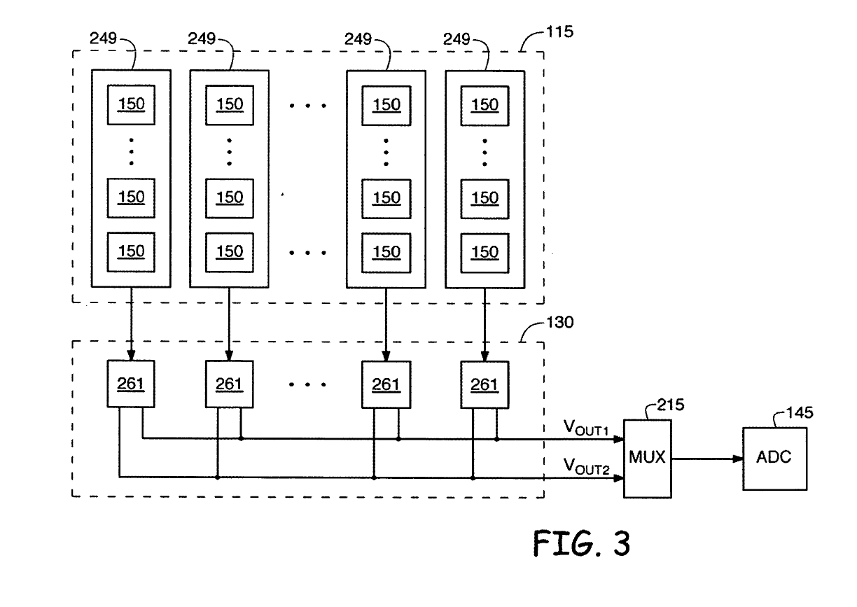

Imager device 110 includes a pixel array 115 having individual pixels arranged in columns and rows. Each of the individual pixels can be accessed using a row and column address in a fashion similar to that used for memory. The pixel array 115 can include both non-dark 115A and dark pixels 115B as illustrated in FIG. 2. Dark pixels 115B can be used for various purposes such as compensating for Fixed Pattern Noise (FPN) occurring in the readout circuitry for the columns (as described in connection with FIGS. 3, 4 and 5). Sources of this type of FPN can be, for example, signal coupling, resistive metal lines, charge injections, and transistor mismatch.

Although not shown in FIG. 2, pixel array 115 can also have an additional group of dark pixels for correcting FPN in rows. The term “dark pixel” refers to a pixel that is prevented from receiving electromagnetic radiation by, for example, covering it with an opaque material.

A timing and control unit 140 (FIG. 1) can coordinate the capture and retrieval of image data using an address that can be decoded by both a column decoder 135 and row decoder 120 to indicate a row and the columns of the pixels 115 residing in the indicated row.

A row driver 125 can select an indicated row for the capture and retrieval of the image data. A column driver 130 can retrieve the stored image data for each of the pixels 115 contained in the selected row and provide a sampled signal to the Analog to Digital Converter (ADC) 195 for conversion to a digital signal. The digital signal from the ADC 195 can be provided to an image processor 180 (internal or external) for further processing.

A memory unit 155 can store corrective information that can be used by the ADC 195 and/or processor 180 to compensate for FPN generated from the column driver 130 as explained in greater detail below. The location and manner in which the memory unit 155 is accessed is designer specific and can be either internal or external. Memory unit 155 can be any type of modifiable memory (e.g., RAM, EEPROM, etc.).

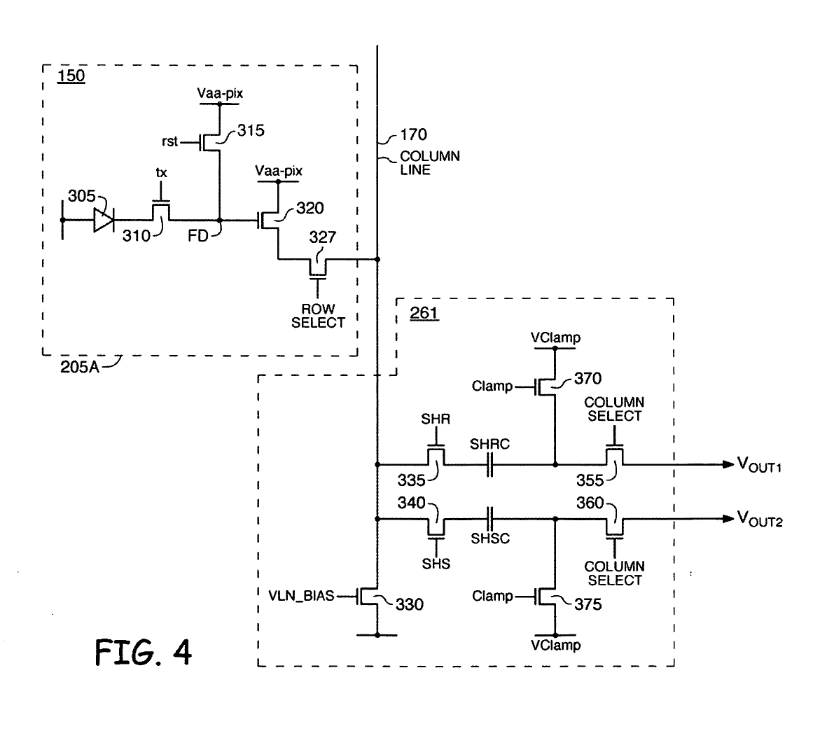

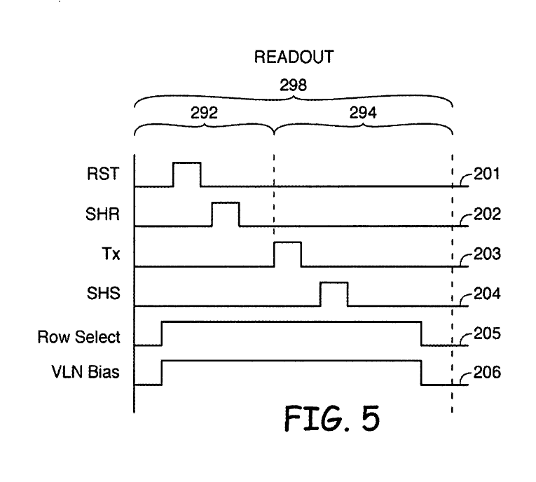

FIG. 3 is a diagram illustrating an embodiment of the column driver 130 and pixel array 115 of FIG. 1. The individual pixels ISO of pixel array 115 can be arranged into rows and columns 249 as shown. The column driver 130 can include a sample and hold circuit 261 for each one of the columns 249 that can read and store signals (e.g., pixel reset and integrated charge) from the associated pixels 150. These stored signals can be read sequentially column-by-column and provided to a multiplexer 215 for conversion by the ADC 195 (FIG. 1). The readout and storage of the signals from a pixel 150 is discussed below in connection with FIGS. 4 and 5.

FIG. 4 is a schematic diagram illustrating an embodiment of a pixel 150 and the corresponding sample and hold circuit 261 of FIG. 3.

The embodiment of pixel 150 includes four transistors (transfer 310, reset 315, source follower 320, and row select 327), a Floating Diffusion (FD), and a photosensor 305. In this particular embodiment, pixel 150 is implemented with four transistors (4T). It should be noted, however, that other implementations may use more or less transistors (e.g., 5T or 3T).

Photosensor 305 represents a structure that generates a charge in proportion to the amount of electromagnetic radiation it receives and can be, for example, a pinned photodiode (as shown), photogate, or the like.

Transfer transistor 310 is positioned between the photosensor 305 and FD and transfers the generated charge from the photosensor 305 to the FD upon activation from a transfer signal (tx).

Reset transistor 315 is Coupled between voltage potential vaa-pix and the FD and sets the FD, and optionally the photosensor 305, to a known state upon activation by a reset signal (tx).

The source follower transistor 320 converts the charge received on its gate from the FD into an electrical output voltage signal.

The row select transistor 327 is controllable by a row select signal ROW SELECT for selectively connecting the source follower transistor 320 and its output voltage signal to a column line 170 coupled to a sample and hold circuit 261.

Sample and hold circuit 261 includes transistors (bias 330, sample reset 335, sample signal 340, clamps 370 and 375, and column selects 355 and 360), and sample and hold capacitors SHSC and SHRC.

The bias transistor 330 biases the column line 170 during the sampling of the output voltage from the source follower 320.

As previously discussed, FPN can be introduced during the sampling of the image signals from the pixel array 115. Correlated Double Sampling (CDS) is one method that can be used to assist in compensating for FPN as explained below.

The sample and hold circuit 261 can implement a CDS method where a reset state (i.e., a known charge) can be read from the FD, stored on the SHRC capacitor and then the charge generated from the pixel 150, during integration, can be read from the FD and stored on the SHSC capacitor. These stored values can then be subtracted one from another to assist in compensating for FPN and to calculate the voltage generated during the integration of the photodiode 305.

FIG. 5 is a timing diagram illustrating an embodiment of the timing of the signals for the implementation of the CDS method using pixel 150 and sample hold circuit 261 of FIG. 4 as an example. In the current embodiment, the CDS scheme is implemented by the timing and control unit 140 in combination with the column driver 130. It should be noted, however, that the control and timing could be performed by other components either singularly or in combination.

During an image acquisition period, the column line 170 can be maintained at a high level and the pixel 150 can be isolated from the column line 170. The column line 170 can be maintained at a high level by the disabling of the bias transistor 330 (via the VLN_Bias signal 206). Pixel 150 can be isolated from the column line 170 by disabling the row select transistor (via the Row Select signal 205).

A readout period 298 for pixel 150 can include a reset readout 292 and an integrated charge readout 294. The reset readout 292 couples the pixel 150 to the column line 170, resets the FD to Vaa-pix, and samples the FD. The coupling of the column line 170 to the pixel 150 can be accomplished with the activation of the bias transistor 330 (via the VLN_Bias signal 206), and the activation of the row select transistor 327 (via the Row Select signal 205). The FD can be reset to Vaa-pix with the activation of the reset transistor 315 (via rst signal 201). The sampling of the FD can occur with the activation of sample reset transistor 335 (via SHR signal 202) where the sampled signal (Vrst) is transferred to the column line 170 by route of the source follower transistor 320, row select transistor 327 and stored on the SHRC capacitor.

The integrated charge readout 294 continues after the reset readout 292 with the transfer of the integrated charge from the photodiode 305 to the FD and the sampling of the transferred charge (Vsig). The integrated charge can be transferred to the FD when the transfer transistor is activated (via the Tx signal 203). The sampling of die transferred charge can occur with the activation of sample signal transistor 340 (via the SHS signal 204) where the sampled Vsig signal is transferred to the column line 170 by the route of the source follower transistor 320, row select transistor 327 and stored on the SHSC capacitor.

The readout signals (Vsig and Vrst) can be stored on the SHSR and SHSC capacitors until they are readout and processed by the ADC converter 195 (FIG. 1).

The above described CDS process can be followed for the reading of signals from both the dark 115B and non-dark pixels 115A (FIG. 2). The sampling of the dark pixels 115B can occur prior to the sampling of the non-dark pixels 115A. The sampling of the dark pixels 115B provides additional data that is used to further compensate for FPN that is generated from column settling, the column multiplexer (e.g., Mux 215), and SHSR and SHSC capacitor leakage.

The rows of dark pixels 115B can be sampled a predetermined number of times and the samples manipulated (e.g., averaged, binned, statistics, etc.) to form a correction value for each column 249 that can be stored in memory 155.

As each of the non-dark pixels 115A are sampled and converted to a digital signal by the ADC 195 (FIG. 1), the digital representation can be adjusted to incorporate the correction value (e.g., subtracted, added or other desired manipulation).

The sampling of the signals (e.g., Vrst and Vsig) from dark pixels 115B is typically used for compensating column settling FPN issues. Unfortunately, reading the signals from the dark pixels 115B also introduces additional noise from the dark pixel 115B such as dark FPN and temporal noise (e.g., source follower). Consequently, any sampling of the dark pixels 115B must include additional samples to compensate for this added noise.

The inclusion of dark pixels 115B also requires additional processing (e.g., the prevention of electromagnetic radiation from reaching the dark pixels 115B) during manufacture and decreases the available space for non-dark pixels 115A or added.

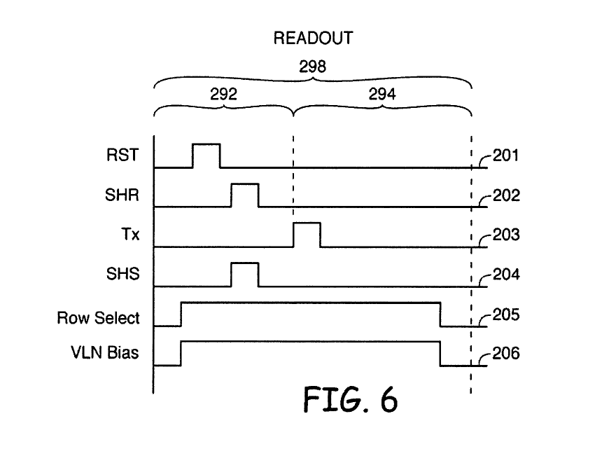

Various embodiments of the present invention can avoid the use of dark pixels, and therefore, the additional manufacturing steps (e.g., metal covering) and provide the ability to use the space previously occupied by these dark pixels 115B for additional resolution or functionality as described in connection with FIG. 6 below.

FIG. 6 is a timing diagram illustrating an embodiment of the timing of the signals for the implementation of a modified CDS scheme using pixel 150 and sample hold circuit 261 of FIG. 4 as an example. As shown, the timing sequence is similar to that previously described in connection with FIG. 5 with the exception that the SHR and SHS signals now occur at substantially the same time.

This new timing of the SHR and SHS signals results in simultaneous storing the Vrst signal on both the SHRC and SHSC capacitors while ignoring any charge accumulated from the photodiode 305. This modified CDS timing scheme can be generated with only a slight modification to the timing used for the CDS by, for example, coupling the SHS signal to the SHR signal during FPN compensation. The modified CDS timing scheme (FIG. 6), results in the loss of some compensation for column settling induced FPN, but improves compensation for FPN induced by sample and hold capacitor leakage and FPN associated with column readout circuitry. The modified CDS timing scheme reduces the number of samples needed to compensate FPN since it reduces certain types of readout noise sources, such as white noise, 1/f-noise from the source follower 320 as well as power supply noise and ground bounce noise.

In addition, the elimination of the time required to transfer and read the integrated charge from the photodiode 305 and the additional sources of FPN provides the ability to take an acceptable number of samples from dynamically selected pixels 115A in a shorter period of time when compared to the traditional CDS method. This timing scheme also allows the use of non-dark pixels, such as pixels 115A, to calculate FPN (hereinafter referred to as “FPN pixels”). As such, the FPN pixels can be dynamically selected from anywhere within the pixel array 115A whether contiguous or non-contiguous and the number of FPN pixels can also be dynamically altered as necessary according to the type of FPN correction desired. The FPN pixels can also be combined with dark pixels to further supplement FPN compensation (add rows and/or columns) as explained below.

In the present embodiment, the selection, control and tracking of the FPN pixels is performed by the timing and control unit 140 in combination with the column driver 130 and memory 155. It should be noted, however, that the control and tracking could be performed by other components either singularly or in combination.

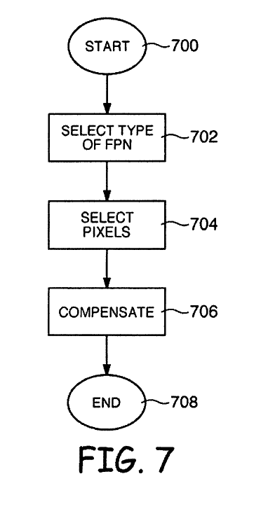

FIG. 7 is a flow chart illustrating an example of an embodiment of a method for selecting and dynamically changing the number and location of FPN pixels. The selection of FPN pixels can be based upon the type and extent to which FPN is required to be compensated (Steps 702-704).

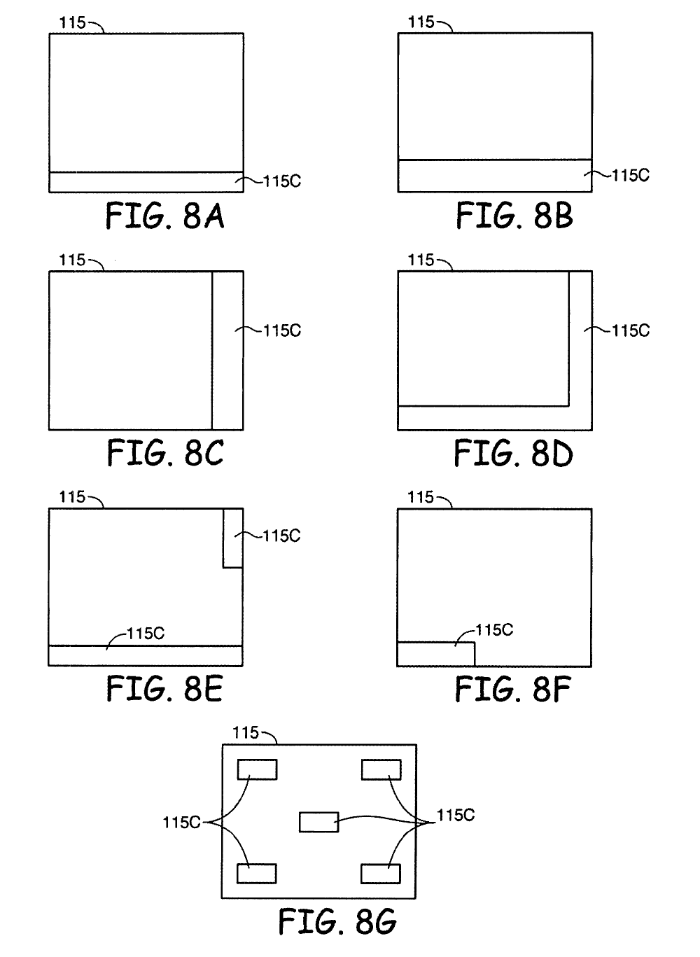

For example, column FPN may be the only or initial concern and so a limited number of FPN pixels 115C can be selected for column FPN compensation purposes as illustrated in FIG. 8A. In another example, the amount of FPN pixels 115C initially selected for column FPN could be determined to be insufficient and the number of FPN pixels 115C for this purpose expanded as illustrated in FIG. 8B.

In yet another example, it could be determined that compensation is only required for row FPN and the selection can include the elimination of the column FPN pixels 115C from FIG. 8B and the addition of row FPN pixels 115C as illustrated in FIG. 8C.

It can also be determined that column FPN compensation is required in addition to the row FPN compensation and FPN pixels 115C can be dynamically selected as indicated in FIG. 8D.

FIGS. 8E-F illustrate the initial selection of FPN pixels 115C for column and row FPN in FIG. 8D dynamically altered to decrease the number of FPN pixels 115C for either row (FIG. 8E) or column (FIG. 8F) FPN compensation purposes.

Example 8G illustrates a selection of FPN pixels 115C distributed throughout the pixel array 115A for column and/or row FPN correction purposes.

Although not shown, the selection of FPN pixels could be used to temporarily or permanently supplement a number of dark pixels for FPN purposes. For example, an imager having a limited number of dark pixels could have an additional number of FPN pixels added for one or both column and row FPN purposes.

The selected FPN pixels 115C are then used to compensate for FPN noise (column and/or row) as previously described (Steps 706-708).

Various embodiments, in which the present invention can be practiced, have been illustrated and described above solely for the purpose of providing a convenient and enabling discussion of the applicability of the present invention to one or more specific applications. These embodiments are not, therefore, intended to limit the various additional embodiments or applications to which the present invention can be applied as defined in the claims and their equivalents.

What is claimed is:

1. An imager comprising:
a pixel array having a plurality of first and second pixels that each generate a charge in response to receiving electromagnetic radiation; and
a noise sampling circuit that samples noise generated from the second pixels without sampling the generated charge from the second pixels.

2. The imager of claim 1 further comprising:
a compensation circuit that modifies the generated charges from the first pixels using the sampled noise.

3. The imager of claim 2 wherein the noise sampling circuit includes:
column reading circuitry that samples the generated charges from the first pixels and the noise generated by the second pixels.

4. The imager of claim 3 wherein each of the first and second pixels include:
a photodiode that generates the charge in response to being struck by electromagnetic radiation;
a floating diffusion that stores the generated charge; and
a reset transistor that sets the floating diffusion to a known state prior to reading the generated charge.

5. The imager of claim 4 wherein the noise sampling circuit includes:
a sample circuit that performs correlated double sampling on each of the first pixels, and samples only the known state for the second pixels.

6. An imager device comprising:
a first group of pixels that generate a charge in response to being struck by electromagnetic radiation;
a second group of pixels that are inhibited from receiving electromagnetic radiation; and
a noise sampling circuit that samples noise generated from the second group of pixels without sampling any charge generated by the second group of pixels.

7. The imager device of claim 6 further comprising:
a compensation circuit that uses the sampled noise to modify the generated charges from the first group of pixels.

8. The imager device of claim 7 wherein the noise sampling circuit, during operation of the imager device dynamically selects a plurality of pixels from the first group of pixels for sampling noise.

9. The imager device of claim 8 wherein the compensation circuit uses the sampled noise from the selected group of pixels to modify the generated charges from the first group of pixels.

10. A method of reading image data from an imager device, the method comprising:
exposing a pixel array having a first and second set of pixels that each generate a charge in response to being struck by electromagnetic radiation;
sampling the generated charges from the first set of pixels; and
sampling noise generated from the second set of pixels without sampling the generated charges by the second set of pixels.

11. The method of claim 10 wherein the step of sampling the generated charges from the first set of pixels includes:
sampling a known state from each of the first set of pixels;
sampling the generated charges from the first set of pixels; and
subtracting the known state from the generated charge for each of the first set of pixels to generate a sampled value.

12. The method of claim 11 wherein the step of sampling the noise generated from the second set of pixels includes:
sampling a first known state and a second known state from each of the second set of pixels, the first known state being equal to the second known state; and
subtracting the first known state from the second known state for each of the second set of pixels.

13. The method of claim 10 wherein the step of sampling the generated charges from the first set of pixels includes:
resetting, for each of the first set of pixels, a floating diffusion to a first known state;
sampling, for each of the first set of pixels, the first known state from the floating diffusion;
resetting, for each of the first set of pixels, the floating diffusion to a second known state;
transferring, for each of the first set of pixels, the generated charge from a photodiode to the floating diffusion;
sampling, for each of the first set of pixels, the transferred charge from the floating diffusion; and
subtracting, for each of the first set of pixels, the sampled first known state from the sampled charge.

14. The method of claim 13 wherein the step of sampling the noise generated from the second set of pixels includes:
resetting, for each of the second set of pixels, a floating diffusion to a first known state;
sampling, for each of the second set of pixels, the first known state from the floating diffusion;
resetting, for each of the second set of pixels, the floating diffusion to a second known state;
sampling, for each of the second set of pixels, the second known state from the floating diffusion; and
subtracting, for each of the second set of pixels, the sampled first known state from the sampled second known state.

15. The method of claim 10 wherein the step of sampling the generated charges from the first set of pixels is performed according to a correlated double sampling scheme.

16. The method of claim 15 wherein the step of sampling the noise generated from the second set of pixels includes:
sampling for a first time, for each of the second set of pixels, a known state from a floating diffusion.
sampling for a second time, for each of the second set of pixels, the known state from the floating diffusion; and
subtracting, for each of the second set of pixels, the first sampled known state from the second sampled known state.

17. A method of sampling image data from an image device having an imager with a pixel array including a first and second set of pixels each having a photodiode that generates a charge in response to being struck by electromagnetic radiation, the method comprising:
sampling the generated charge from the first set of pixels;
sampling noise generated from the second set of pixels without including the generated charge from the second set of pixels; and
adjusting the sampled charges using the sampled noise.

18. The method of claim 17 wherein the step adjusting the sampled charges includes:
converting each of the sampled charges to a digital representation; and
modifying the digital representations using the sampled noise to account for noise in the sampled charges.

19. The method of claim 17 wherein the step of sampling the generated charge from the first set of pixels includes:
sampling the generated charges from the first set of pixels using a correlated double sampling scheme.

20. The method of claim 19 wherein the step of sampling the noise generated from the second set of pixels includes:
sampling a known value from each of the second pixels that does not include the generated charge from the second pixels.

21. A method of compensating for noise generated in an imager device, the method comprising the steps of:
selecting first and second sets of pixels from a group of pixels in an array, each one of the pixels generating a charge in response to being struck by electromagnetic radiation;
exposing the group of pixels to electromagnetic radiation; and
sampling noise generated from the second set of pixels without sampling the generated charges by the second set of pixels.

22. The method of claim 21 further comprising:
sampling the generated charges from the first set of pixels.

23. The method of claim 22 wherein the step of sampling the noise generated from the second set of pixels includes:
sampling a first known state from each of the second set of pixels;
sampling a second known state from each of the second set of pixels; and
subtracting the first known state from the second known state for each of the second set of pixels.

24. The method of claim 23 wherein the step of sampling the generated charges from the first set of pixels includes:
sampling a known state from each of the first set of pixels;
sampling the generated charges from the first set of pixels; and
subtracting the known state from the generated charge for each of the first set of pixels to generate a sampled value.

25. The method of claim 24 wherein the step of sampling the noise generated from the second set of pixels includes:
sampling for a first time, for each of the second set of pixels, a known state from a floating diffusion;
sampling for a second time, for each of the second set of pixels, the known state from the floating diffusion; and
subtracting, for each of the second set of pixels, the first sampled known state from the second sampled known state.
